(19) United States
(12) Patent Application Publication
(10) Pub. No.: US 2023/0192983 A1
(43) Pub. Date: Jun. 22, 2023

(54) COMPOSTABLE OXYGEN BARRIER COMPRISING A BIODEGRADABLE POLYMER MATRIX AND BIOCARBON

(71) Applicant: University of Guelph, Guelph (CA)

(72) Inventors: Amar MOHANTY, Guelph (CA); Feng WU, Guelph (CA); Manjusri MISRA, Guelph (CA); Akhilesh PAL, Guelph (CA); Arturo RODRIGUEZ-URIBE, Guelph (CA); Tao WANG, Guelph (CA)

(73) Assignee: University of Guelph, Guelph, ON (CA)

(21) Appl. No.: 17/925,549

(22) PCT Filed: May 14, 2021
(86) PCT No.: PCT/CA2021/050667

§ 371 Date: Nov. 15, 2022

Related U.S. Application Data
(60) Provisional application No. 63/025,607, filed on May 15, 2020.

(51) Int. Cl. C08K 3/04; B65D 85/804; B65D 1/34; C08K 3/34; C08L 67/02; C08L 67/04; C08J 5/18

(52) U.S. Cl. CPC C08K 3/04; B65D 85/8043; B65D 1/34; C08K 3/34; C08L 67/02; C08L 67/04; C08J 5/18; C08L 2201/06; C08L 2201/14; C08L 2203/16; C08L 2203/30; C08L 2205/08; C08K 2003/343; C08J 2367/02; C08J 2367/04; C08J 2403/02; C08J 2451/00

(57) ABSTRACT

A biodegradable composite comprising a polymeric matrix including but not limited to poly lactide (PLA), poly (butylene succinate) 20 (PBS), poly(butylene succinate adipate) (PBSA), including bio-based PBSA (BioPBSA), poly(butylene adipate-co-terephthalate) (PBAT), polycaprolactone (PCL), polyhydroxyalkanoate (PHA(s)), poly(3-hydroxy)butyrate (PHB), poly(3-hydroxy-butyrate-hydroxyvalerate) (PHBV), copolyester of the monomers 1.4-butanediol, adipic acid and terephthalic acid (Ecoflex™) and polypropylene carbonate (PPC), and biocarbon, a.k.a. biochar or pyrolyzed biomass as a sustainable filler. The biodegradable composite achieves high oxygen barrier with balanced water barrier. Also, a method of manufacturing the biodegradable composite and articles of manufacturing comprising the biodegradable composite. The articles of manufacturing have application in limiting gas permeation into a package and extending shelf life of a material.

### CROSS REFERENCE TO RELATED APPLICATIONS

This application is a national stage application under 35 U.S.C. 371 of International Application No. PCT/CA2021/050667, filed May 14, 2021, which in turn claims the benefit under 35 U.S.C. 119(e) of U.S. Provisional Ser. No. 63/025,607, filed May 15, 2020, the contents of each of which are hereby incorporated by reference into the present disclosure.

### FIELD OF INVENTION

The present invention relates to gas barriers, more specifically, to a biodegradable oxygen barrier.

### BACKGROUND OF THE INVENTION

Plastic packaging with a high oxygen/water barrier has benefits in our daily life by offering stable and extended shelf life to many ready-to-eat food products in the market. This leads to a boost in the global plastic packaging industry. According to a new report released by Grand View Research, Inc., the global food packaging market size is expected to reach USD 411.3 billion by 2025, registering a compound annual growth rate of 5.1% during the forecast period. To achieve high gas and water barrier, multi-layer structured films are commonly used. The multi-layer structures are believed to hamper the recyclability of those packaging materials, as material with high purity are needed for reprocessing. Also, most commercial multilayer films available today are not renewable or biodegradable because of the predominant use of non-biodegradable petroleum-based polymers. For example, a multi-layer material consisting of polypropylene/polyethylene terephthalate (PP/PET) has been used to package pharmaceutical products in which PP provides an excellent water barrier and PET provides an excellent oxygen barrier [1]. Another example is ethylene vinyl alcohol (EVOH) which is often incorporated into multilayer structures for food packaging to provide an excellent oxygen barrier [2, 3].

With increasing concerns on environmental pollution caused by plastic waste, renewable and biodegradable polymers have drawn wider interest in academic and industrial sectors. However, biodegradable polymers with comparable oxygen or water barrier to the current petroleum-based polymers like PP or PET are absent in the current market for real-world applications. Developing biodegradable polymer blends or composites with excellent oxygen/water barrier properties is significantly important for food packaging applications. The barrier properties are closely related to the mass transfer properties of the polymers, including permeability, diffusivity and solubility of various gases and water vapor in the polymers. The permeation of gas/water vapor in the polymers can be divided into four steps: absorption of the permeating species into the polymer surface, solubility into the polymer matrix, diffusion through the wall along a concentration gradient, and finally desorption from the outer surface [4]. Accordingly, various strategies have been used to improve the barrier by decreasing the absorption, solubility, diffusion, and desorption of the permeant in polymers. Surface coating is a widely used technology to decrease the absorption and desorption of oxygen or water in contact with polymers [5]. For example, by coating all-organic poly(vinyl alcohol) (PVA) and tannic acid (TA) on PLA, the templated layer-by-layer polylactide (PLA) composites show excellent oxygen barrier of 0.52×10⁻¹⁶ cc·cm/(cm²·s·Pa), 450 times lower than pure PLA [6]. Other strategies include increasing the crystallinity, which will decrease the solubility as well as the diffusion rate [7], and increasing chain orientation [8] which decreases the diffusion rate of the permeant vertical to the chain direction are also reported to improve the barrier of the polymers. Other methods like incorporating in-situ nanofibrils of polybutylene succinate (PBS) [9] or polybutylene adipate terephthalate (PBAT) [10] into PLA are also found to increase the barrier of polymers, by creating a “nano-barrier wall” to decrease the diffusion rate of the oxygen gas. Oxygen scavenger was also reported to improve the oxygen barrier properties [11, 12]. However, the use of oxygen scavengers has its own challenges, including high melt processing, unwanted migration of the oxidation products and sometimes their unpleasant taste.

A filler system is attractive to increase the barrier properties of polymers for economic benefits, ease of processing and high efficiency. Talc [13, 14], nano-clay [15], graphene and graphene oxide [16], cellulose nanocrystals [17], halloysite [18], chitosan [19], etc., have been used in biopolymers to improve their barrier properties. In the 1990s, U.S. Pat. No. 5,153,039 [14] reported that incorporating mica and talc can effectively improve the oxygen barrier of high-density polyethylene (HDPE). Generally, it is desirable to treat the fillers, e.g., the clays or talcs, to facilitate the separation of the agglomerates of platelet particles to individual particles. Thus, the barrier properties can be improved, as described in US publication 2009/0286023 [20]. However, such treatment is normally costly, let alone the high cost of fillers like graphene and graphene oxide themselves.

Biocarbon is generally defined as the solid carbon-rich residue obtained from the thermal decomposition of biomass in the absence of oxygen [21]. The procedure to produce biocarbon is normally called pyrolysis, which is defined as the chemical and thermal decomposition of organic materials at a temperature greater than 400° C. in the absence of oxygen [22]. The biocarbon produced in this way is reported to have high porosity and large relative surface areas [23]. Due to its carbon-rich, high porosity and large surface area, biocarbon has been widely reported to be used in soil amendments [24], conductivity, supercapacitor [25] and adsorbent for various wastewater treatments [26]. Also, biocarbon has been mixed with polymers to improve their stiffness (modulus), heat deflection temperature (HDT) or decrease their coefficient of linear thermal expansion (CLTE). Studies on biocarbon filled composites have so far focused mainly on the modification of thermo-mechanical properties of the polymeric matrices. The only research work published to date that has assessed the effect of biocarbon addition on the oxygen barrier properties of a biopolymer is the inventors' own previous study on comparing biocarbon and talc filled PLA composites [27]. That 2019 publication reported an increased oxygen permeability (decreased barrier) of PLA with the addition of 10 wt. % biocarbon. The permeability data as reported [27]. Our latest extensive research has clearly demonstrated that the oxygen barrier of PLA improves with the addition of biocarbon, which is disclosed in the present invention filing. In another research, poly(3-hydroxybutyrate-co-3-hydroxyvalerate) (PHBV)/Biocarbon composites showed higher modulus as compared to PHBV, with the biocarbon obtained from lignocellulosic materials showing high stiffness and hardness [28].

### SUMMARY OF THE INVENTION

The present invention relates to a novel class of biodegradable composites filled with biocarbon and hybrid fillers comprising biocarbon, starch, talc and graphite for industrial packaging applications, exhibiting possible compostability, excellent oxygen barrier and significant/affordable water barrier. In one aspect, the composite formulation is designed to demonstrate an excellent oxygen barrier superior to EVOH, which is known as an oxygen barrier polymer, to replace the traditional petroleum-based polymers in packaging applications requiring super-high oxygen barrier. In another aspect, the composite formulation is designed to exhibit a high-water barrier superior to polystyrene, to replace the traditional petroleum-based polymers in some special applications requiring moderate water barrier. In some embodiments, the biodegradable composites of the present invention exhibit compostability, including home compostability.

In some of the embodiments, the composites of the present invention utilize one-step extrusion to fabricate high barrier biodegradable composites with hybrid fillers up to 60 wt %. The invention also relates to the reactive extrusion to control the melt flow index (MFI) of the composites. Thus, the desired formulations can be used in injection molding, blow molding, blown film or thermoforming types of molded products.

In one embodiment, the present invention relates to high oxygen barrier biodegradable composites. The biodegradable composites, in one embodiment, includes: (a) a polymeric matrix comprising one or more biodegradable polymers (b) a filler selected from a sustainable biocarbon pyrolyzed from different biomass or a hybrid filler of biocarbon with a second filler selected from the group consisting of one or a combination of two or more of the following: (1) waste starch from corn, potato or wheat (2) inorganic mineral fillers such as talc or clay and (3) other fillers such as graphite or graphene or graphene oxides.

In one embodiment, the present invention relates to high melt strength, high oxygen/water barrier biodegradable composites. The biodegradable composites, in one embodiment, includes: (a) a polymeric matrix comprising two (binary) or more (ternary and quaternary) biodegradable polymers (b) a filler selected from a sustainable biocarbon pyrolyzed from different biomass or a hybrid filler of biocarbon with a second filler selected from the group consisting of one or a combination of two or more of the following: (1) waste starch from corn, potato or wheat (2) inorganic mineral fillers from talc or clay (3) other fillers such as graphite or graphene or graphene oxides; (c) an in-situ compatibilizer: free radical initiator derived from organic peroxide, superoxide, hydroxyl radical, and singlet oxygen.

As such, in one embodiment, the present invention is a gas barrier substrate comprising a biodegradable composite, the biodegradable composite comprising a polymeric matrix and a sustainable filler comprising biocarbon.

In one embodiment of the gas barrier substrate of the present invention, the biodegradable composite has an oxygen transmission rate of 55 cc/m²-day or less, or an oxygen transmission rate of 20 cc/m²-day or less, or an oxygen transmission rate of 10 cc/m²-day or less, or an oxygen transmission rate of 2 cc/m²-day or less, or an oxygen transmission rate of 1 cc/m²-day or less, or an oxygen transmission rate of 0.2 cc/m²-day or less, wherein the oxygen transmission rate is calculated at normalized thickness of the biodegradable composite of 25.4 micrometer (1 mil) at 0% relative humidity, 23.7° C.

In another embodiment of the gas barrier substrate of the present invention, the biodegradable composite has a water permeation rate of 300 g/m²-day, or less or has a water permeation rate of 150 g/m²-day or less, or a water permeation rate of 130 g/m²-day or less, or a water permeation rate of 125 g/m²-day or less or a water permeation rate of 10 g/m²-day or less, wherein the water permeation rate is calculated at normalized thickness of the biodegradable composite of 25.4 micrometer (1 mil) at 100% relative humidity, 37.8° C.

In another embodiment of the gas barrier substrate of the present invention, the polymeric matrix comprises one or more biodegradable polymers.

In another embodiment of the gas barrier substrate of the present invention, the polymer matrix comprises one or more of polylactide (PLA), poly(butylene succinate) (PBS), BioPBS (bio-based PBS), poly(butylene succinate adipate) (PBSA), BioPBSA (bio-based PBSA), poly(butylene adipate-co-terephthalate) (PBAT), polyhydroxyalkanoates (PHAs) including poly(3-hydroxy)butyrate (PHB) and poly(3-hydroxybutyrate-hydroxyvalerate) (PHBV), and a copolyester of 1.4-butanediol, adipic acid and terephthalic acid (Ecoflex™).

In another embodiment of the gas barrier substrate of the present invention, the polymeric matrix comprises a binary blend of PBS/PBSA, PBS/PBAT, BioPBSA/the copolyester of 1.4-butanediol, adipic acid and terephthalic acid or PBSA/PBAT, or a ternary blend of PLA/PBS/PBAT, PHBV/BioPBSA/the copolyester of 1.4-butanediol, adipic acid and terephthalic acid or PBSA/PBAT/PHBV, or a quaternary blend of PLA/PBS/PBAT/PHBV or PLA/BioPBS/PBAT/PHBV.

In another embodiment of the gas barrier substrate of the present invention, the polymeric matrix comprises PBS, PHBV or PLA as a major component of the polymeric matrix.

In another embodiment of the gas barrier substrate of the present invention, the biodegradable composite is free of ethylene vinyl alcohol (EVOH) or polyvinyl alcohol (PVOH).

In another embodiment of the gas barrier substrate of the present invention, the sustainable filler is a hybrid filler comprising (a) the biocarbon, and (b) a second filler selected from one or more of: starch; inorganic mineral fillers from talc or clay; and graphite or graphene.

In another embodiment of the gas barrier substrate of the present invention, the sustainable filler is a hybrid filler comprising (a) the biocarbon and (b) starch.

In another embodiment of the gas barrier substrate of the present invention, the sustainable filler is a hybrid filler comprising (a) the biocarbon and (b) talc or graphite.

In another embodiment of the gas barrier substrate of the present invention, the biodegradable composite comprises up to 40 wt % of sustainable fillers.

In another embodiment of the gas barrier substrate of the present invention, the gas barrier substrate is in the form of a pellet, a granule, an extruded solid, an injection molding solid, a hard foam, a sheet, a layer, a film, a dough or a melt.

In another embodiment of the gas barrier substrate of the present invention, the size of the biocarbon effects the barrier properties of polymer/polymer blends/polymer composites.

In another embodiment of the gas barrier substrate of the present invention, the oxygen transmission rate of the gas barrier substrate is lower than the oxygen transmission rate of each one of PET, Nylon or EVOH.

In another embodiment of the gas barrier substrate of the present invention, the biocarbon is one or more of pyrolyzed miscanthus, pyrolyzed coffee chaff, pyrolyzed soy hull, pyrolyzed wood, pyrolyzed coffee ground or pyrolyzed oat hull.

In another embodiment of the gas barrier substrate of the present invention, the biodegradable composite further comprises a compatibilizer from peroxide or maleic anhydride-grafted biopolymers.

In another embodiment of the gas barrier substrate of the present invention, the gas barrier substrate is industrial compostable or home compostable.

In another embodiment of the gas barrier substrate of the present invention, the gas barrier substrate is a single layer gas barrier.

In another embodiment of the gas barrier substrate of the present invention, the gas barrier substrate is a multilayer gas barrier film, wherein at least one layer that forms the multilayer film exhibits gas barrier properties.

In another embodiment, the present invention is an article of manufacture comprising the gas barrier substrate of the present invention.

In one embodiment the article of manufacture is a packaging in shape of film, sheet, injection molded or thermoformed shapes.

In another embodiment, the article of manufacture is a packaging in shape of a coffee pod.

In another embodiment, the present invention is a method of limiting gas permeation into an interior of a package, the method comprising at least partially or entirely covering the package with an article of manufacture of the present invention.

In another embodiment, the present invention is a method of protecting a material from gas present in the environment, the method comprising at least partially or entirely covering the material with a gas barrier substrate of the present invention so as to prevent the gas from permeating through the gas barrier substrate.

In another embodiment, the present invention is a method of improving shelf life of a material which shelf life is reduced when exposed to a gas, the method comprising at least partially or entirely covering the material with a gas barrier substrate of the present invention.

In one embodiment of the methods of the present invention, the material is at least one of foods, pharmaceuticals, cosmetics, cement, and daily necessaries.

### BRIEF DESCRIPTION OF THE DRAWINGS

The following figures illustrate various aspects and preferred and alternative embodiments of the present invention.

FIGS. 1A-1C. SEM images of macro-size (1A), micron-size (1B), and sub-micron size (1C) wood biocarbon particles.

FIG. 2. Photograph of a three-roll calendaring sheet made of a high barrier biodegradable composite of the present invention.

FIG. 3. Photograph of casting film made of a high barrier composite and the composites with 40 wt % hybrid fillers (biocarbon, talc, starch, graphite) according to aspects of the present invention.

FIGS. 4A-4B. Photographs of thermoformed mushroom tray (4A) and coffee pod (4B) made of a high barrier biodegradable composite formulation and the composites with 40 wt % hybrid fillers (biocarbon, talc, starch, graphite) of the present invention.

### DESCRIPTION OF THE INVENTION

### Definitions

Unless defined otherwise, all the scientific and technical terms used herein have the same meaning as commonly understood by one of ordinary skill in the art to which this invention belongs. Also, unless indicated otherwise, except within the claims, the use of “or” includes “and” and vice versa. Non-limiting terms are not to be construed as limiting unless expressly stated, or the context clearly indicates otherwise (for example, “including”, “having”, “such as” and “comprising” typically indicate “including without limitation”). Singular forms included in the claims such as “a”, “an” and “the” include the plural reference unless expressly stated otherwise. All relevant references, including patents, patent applications, government publications, government regulations, and academic literature are hereinafter detailed and incorporated by reference in their entireties. In order to aid in the understanding and preparation of the within the invention, the following illustrative, non-limiting examples are provided.

The prefix “bio-” is used in this document to designate a material that has been derived from a biological/renewable resource.

The term “renewable resource and/or renewable material and/or renewable polymer” refers to a resource that is produced by a natural process at a rate comparable to its rate of consumption (e.g., within a 100-year time frame). The resource can be replenished naturally, or via agricultural techniques.

The term “biobased content” refers to the percent by weight of a material that is composed of biological products or renewable agricultural materials or forestry materials or an intermediate feedstock.

The term “biodegradable” refers to a composite or product capable of being broken down (e.g. metabolized and/or hydrolyzed) by the action of naturally occurring microorganisms, such as fungi and bacteria.

The term “compostable” refers to a composite or product that satisfies the requirements set by ASTM D6400 for aerobic composting in industrial composting facilities. The term “compostable” also refers to a composite or product that satisfies home compostable requirements, set by AS5810.

The term “macro-size” refers to the average size of particle fillers of less than 1 millimeter (in the range of 100 μm to 1 mm).

The term “micron-size” refers to the average size of particle fillers in the range of 1 μm to 10 μm.

The term “sub-micron size” refers to the average size of particle fillers of less than 1 μm (in the range of 100 nm to 1 micron).

The term “hybrid fillers” refers to the combination of two or more fillers (organic/inorganic) which are either physically or chemically different.

The term “biocarbon” or “biochar” or “pyrolyzed biomass” refers to a carbon rich material (only organic or combination of organic and inorganic) obtained after slow/fast pyrolysis of plant-based biomass or animal-based biomass.

The term “graphite” refers to a crystalline form of carbon, arranged in a regular pattern to form sheet like structure, which occurs as a material in rocks or can be made from coke.

The term “talc” refers to a clay mineral in the powder form, composed of hydrated/non-hydrated magnesium/aluminum silicates.

The term “starch” refers to a polymeric carbohydrate consisting of numerous glucose units joined by glycosidic bonds, consists of two types of molecules: the linear and helical amylose and the branched amylopectin in various proportions.

The term “carbon-rich filler” refers to a combination of inorganic and organic carbons in all possible proportions, obtained from various natural resources.

The term “wax” or “biowax” refers to a waxy material in the powder/flakes/emulsion form, composed of long-chain alkanes, lipids, or similar compounds.

The term “melt strength” refers to the resistance of the polymer melt to stretching, which influence drawdown and sag from the die to the rolls in polymer processing.

The term “free radical initiator” refers to substances that can produce radical species under mild conditions and promote radical reactions. Non-limiting examples of “free radical initiators” that can be used in the present invention include: dibenzoyl peroxide, benzoyl peroxide and dicumyl peroxide, including but not limited to: 2,5-bis(tert-butylperoxy)-2,5-dimethylhexane; 2,5-dimethyl-2,5-di(t-butylperoxy) 3-hexyne; 2,5-dimethyl-2,5-di(t-butylperoxy) hexane; 2,5-dimethyl-2,5-di(t-amylperoxy) hexane; 4-(t-butylperoxy)-4-methyl-2-pentanol; Bis(t˜butylperoxyisopropyl)benzene; 3,6,9-Trirthyl-3,6,9-Trimethyl-1,4,7-Triperoxonane;

Dicumyl peroxide; Ethyl 3,3-bis(t-butylperoxy) butyrate; Ethyl 3,3-bis(t-amylperoxy) butyrate; and, Dibenzoyl peroxide.

The term “wt. %” refers to the weight percent of a component in the composite formulation with respect to the weight of the whole composite formulation.

The term “excellent oxygen barrier” refers to a very low/negligible transmission of oxygen molecules through a film/sheet at specified conditions of temperature and relative humidity at steady state as mentioned in ASTM F3985.

The term “high water barrier” refers to a low transmission of water molecules through a film/sheet at specified conditions of temperature and relative humidity at steady state as mentioned in ASTM F1249.

The term “one-step extrusion” refers to a conventional hot melt-extrusion process in which, heat and pressure are applied to melt a polymer/polymer mixture and forcing it through an orifice in a continuous process.

The term “about” modifying any amount refers to the variation in that amount encountered in real world conditions of producing materials such as polymers or composite materials, e.g., in the lab, pilot plant, production facility. Whether or not modified by about, the amounts include equivalents to those amounts. Any quantity stated herein and modified by “about” can also be employed in the present invention as the amount not modified by about.

### Overview

Henceforth, this document provides detailed description of the embodiments of the present invention.

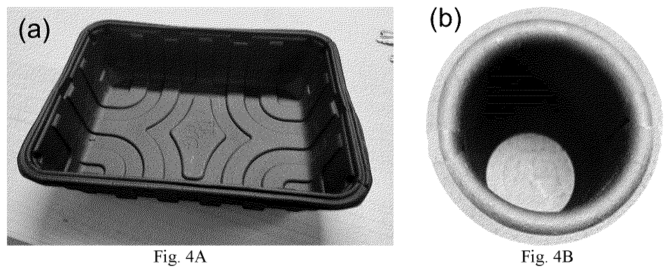

The present invention is a plastic composite in which a sustainable, biocarbon-based filler, including sustainable, biocarbon-based hybrid fillers, is incorporated in different biodegradable polymers and their blends to fabricate high gas barrier sheets (see FIGS. 2 and 3), injection molded or thermoformed shapes that may be used in packaging and other applications where a ultra-high/high gas barrier is desirable, e.g., trays, pouch bags, capsules and other containers for oxygen sensitive products such as cosmetics, chemicals, pharmaceuticals, medical cannabis and food (see FIG. 4). The sustainable filler or sustainable hybrid filler system of the present invention is shown to be effective in obtaining high gas barrier plastic substrates (hereinafter referred to as “substrate” or “substrates”), including ultra-high oxygen barrier, and is economical with one-step single-layer extrusion (cascade engineering). The hybrid system of the present invention also provides improved water, including water vapor, barrier properties sufficient for high oxygen-sensitive packaging use.

The un-common or non-obvious discovery is that biocarbon can be used to dramatically improve the oxygen barrier of biopolymers or mix the biocarbon with other fillers to comprise an effective oxygen and water barrier improvement. Biodegradable biocomposites with super-high oxygen barrier with significant water barrier performance have been obtained in which the oxygen permeation was comparable or lower than known high oxygen barrier petroleum-based polymers e.g. EVOH. Such hybrid filler systems can be engineered without any pre- or post-treatment of the filler components, thus making the whole technology cost competitive. The resulting formulation of the present invention with sustainable fillers can be tailored for film/sheet thermoforming or injection molding for biodegradable (compostable) as well as extremely high barrier packaging applications. The filler system of the present invention includes biocarbon made from different waste residues (including but not limited to soy hull, peanut hull, miscanthus/grass fibers, wood, coffee chaff), and mineral fillers (including but not limited to talc and clay), and/or starch, including waste starch (including but not limited to corn starch), and/or with addition of carbon-rich fillers (including but not limited to graphite). A biodegradable matrix composed of biodegradable thermoplastics and their binary or ternary blends that are reinforced with the above hybrid fillers (single, binary, ternary or quaternary fillers) and which may be produced by reactive extrusion suitable for general purpose application such as food containers/packaging, medical packaging and the like that require excellent barrier performance. The host polymer can be one biodegradable polymer itself such as PBS and PBSA, or binary blends (e.g PBS/PBAT, PBS/PBSA, PBSA/PBAT, BioBSA/Ecoflex™), ternary blends (e.g. PLA/PBS/PBAT, PBSA/PBAT/PHBV, PHBV/BioPBSA/Ecoflex™) and quaternary blends (e.g. PLA/PBS/PBAT/PHBV, PLA/BioPBS/PBAT/PHBV). The composites can be compounded in one-step extrusion in which bioplastics and fillers are mixed together and are added in a main feeder or the biocarbon based filler or hybrid biocarbon with other fillers are added in a side feeder and bioplastics with compatibilizers are added in a main feeder. Conventional casting/blown film, 3-roll calendaring sheeting, injection molding and/or thermoforming, normally used in the synthetic plastic industries, may also be used in the method of processing.

The present biocomposites with above sustainable fillers exhibit excellent oxygen barrier properties similar or superior to petroleum-based polymers, e.g. poly (ethylene terephthalate) (PET), polyvinyl chloride (PVC) and EVOH. The present biocomposites with biocarbon-based fillers exhibit good water barrier similar or superior to polystyrene (PS) and Nylon-6.

The present biocomposites may be formed into useful articles using any of a variety of conventional methods for forming items from plastic. The present biocomposites may make any of a variety of packaging articles like tray, film or containers.

The composites of this invention exhibit excellent barrier for gas, oxygen, and moisture.

As such, the present invention, in one embodiment, provides a method of limiting gas permeation into a package, the method comprising covering at least a portion of the package with an article of the present invention.

The product or material being protected may be a product or material that will have reduced shelf life when exposed to a gas, including oxygen, or to moisture. Examples may include perishable products including produce and foodstuffs, and non-perishable products such as cement, epoxies, and so forth.

### Biocomposites and Method of Manufacturing

The present invention is about a new and non-obvious gas barrier substrate having a filler system to improve the gas and water vapor barrier properties of biodegradable polymeric matrix. This invention can improve the oxygen barrier of biopolymers and their blends to comparable or superior to EVOH which is known and widely used as an excellent oxygen barrier. The lowest oxygen permeation can be decreased to less than 0.07 cc·mil/m²-day via using hybrid fillers of biocarbon, starch, talc and graphite. Also, the present invention is about development and production methods of new biocomposites based on the above-mentioned polymeric matrix and fillers using different processing methods and methods of forming different shapes. The present invention has distinguished points compared to the prior art in aspects of material formulations and barrier improvement.

i. Biodegradability: The biocomposites of the present invention may be formulated in such a way that the final manufactured product will have end-of-life biodegradability (compostability). To develop such a biocomposite, the proposed formulation may include a polymeric matrix from biodegradable plastics, including but not limited to poly lactide (PLA), poly(butylene succinate) (PBS), poly(butylene succinate adipate) (PBSA), including bio-based PBSA (BioPBSA), poly(butylene adipate-co-terephthalate) (PBAT), polycaprolactone (PCL), polyhydroxyalkanoate (PHA(s)), poly(3-hydroxy)butyrate (PHB), poly(3-hydroxybutyrate-hydroxyvalerate) (PHBV), copolyester of the monomers 1.4-butanediol, adipic acid and terephthalic acid (Ecoflex™) and polypropylene carbonate (PPC). In aspects, the biocomposites of the present invention are free of non-biodegradable polymers. In aspects, the biocomposites of the present invention are industrially compostable. In aspects, the biocomposites of the present invention are home compostable.

ii. Renewability: The polymer blends used in the present invention may be produced, at least in part, from renewable resources. Thus, considering the renewability of the filler also the final formulation can be produced from renewable materials higher than 50% by weight of the whole composites.

iii. Filler system: The developed formulation of the present invention includes a novel filler system which may include a single filler or a hybrid filler with a combination of any two or three or four different fillers including but not limited to biocarbon, starch, talc and graphite. Blending may benefit from the specific merits of each moiety in order to balance different properties. To create such a balance, the following aspects may be considered simultaneously: high oxygen barrier (biocarbon, starch), high water barrier (graphite), moderate oxygen/water barrier (talc).

In order to aid in the understanding and preparation of the present invention, the following illustrative, non-limiting examples are provided.

### EXAMPLES

### Materials

The polymeric matrix of the biocomposites of the present invention includes renewable-resource-derived biopolymers such as PLA, PBS, PBSA and the alike, and petroleum-based but biodegradable polymers such as PBAT and the like. It may also include other biodegradable polymers such as PHAs, PCL and PPC and the like. The free radical initiator includes different peroxides, dibenzoyl peroxide, benzoyl peroxide and dicumyl peroxide or the alike maybe used or not used to fabricate the polymeric matrix. The hybrid filler system includes biocarbon (derived from biomass including but not limited to soy hulls, oat hulls, peanut hulls, Miscanthus fibers, wood coffee ground, and coffee chaff), starch (including but not limited to corn starch), mineral fillers including but not limited to talc, clay and carbon-rich fillers including but not limited to graphite. The polymers, initiators, and hybrid filler materials are listed in Table 1, along with the role of individual components, their tradenames, and suppliers.

The sizes of biocarbon used in this invention can be macro-size (below 400 μm), micron-size (1˜10 μm) or sub-micron size (less than 1 μm). The biocarbon used in macro-size and sub-micron size are specified as “macro-size” and “submicron size”, respectively from Table 3 to Table 15, otherwise, the size of biocarbon is micron-size which is specified as “micron-size”. The size of talc used in this invention is either micron-size (1˜10 μm) or submicron size (less than 1 μm). The talc used in submicron size is specified as “submicron size” from Table 3 to Table 15. Otherwise, the size of talc is micron-size. The sizes of starch (˜10 μm) and graphite (˜3 μm) used in this invention are micron-size.

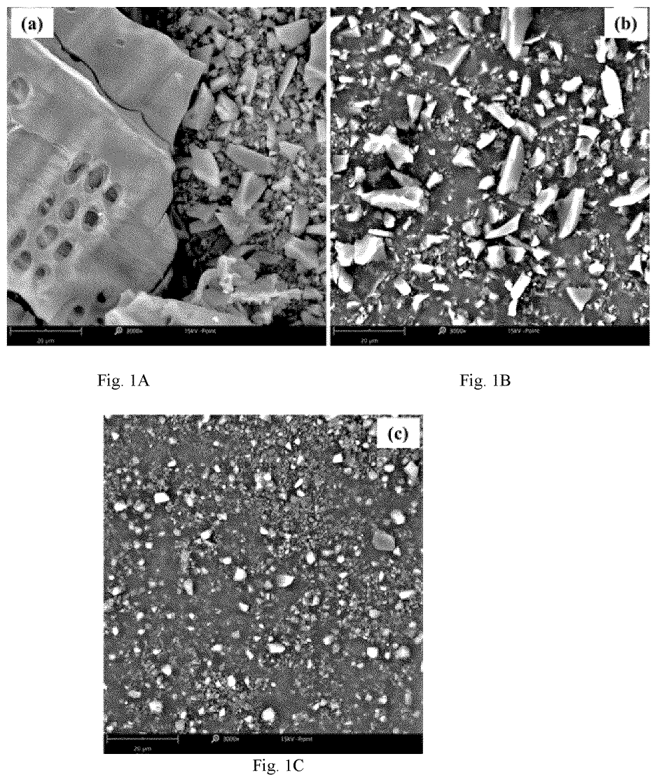

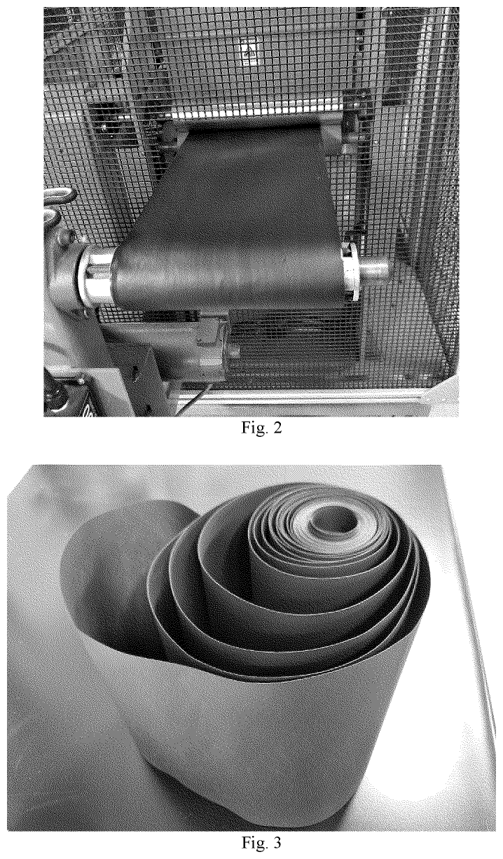

TABLE 1
Materials used to produce the novel formulations proposed in this invention

| | | Information on Materials Used | | |
|---|---|---|---|---|
| Material | Role | Name | Tradename | Supplier |
| Biodegradable | Matrix | PLA | Ingeo 4043D | Natureworks, US |
| Polymers | | PBS | TH803S | Xinjiang Blueridge |
| | | | | Tunhe Chemical |
| | | | | Industry Co., Ltd, |
| | | | | China |
| | | BioPBS | FZ71PM | PTT MCC |
| | | | FZ91PM | Biochem Company |
| | | | | Limited, Thailand |
| | | PBSA | Bionolle ™ | Showa Denko, |
| | | | 3001 MD | Japan |
| | | BioPBSA | FD92PM | PTT MCC |
| | | | | Biochem Company |
| | | | | Limited, Thailand |
| | | PBAT | TH801T | Xinjiang Blueridge |
| | | | | Tunhe Chemical |
| | | | | Industry Co., Ltd, |
| | | | | China |
| | | Ecoflex ™ (a copolyester | F Blend C1200 | BASF |
| | | of the monomers 1.4- | | |
| | | butanediol, adipic acid | | |
| | | and terephthalic acid) | | |
| | | PHBV | ENMATY1000P | TianAn Biologic |
| | | | | Materials, China |
| Free radicals | Compatibilizer | 2,5-dimethyl-2,5-di(t- | Luperox 101 | Sigma Aldrich, |
| | | butylperoxy) 3-hexyne | | Canada |
| | | 3,6,9-Trirthyl-3,6,9- | Trigonox 301 | Sigma Aldrich, |
| | | Trimethyl-1,4,7- | | Canada |
| | | Triperoxonane | | |
| | | Maleic Anhydride | — | Fisher Scientific, |
| | | | | Canada |
| Biocarbon | Filler/Oxygen | Miscanthus biocarbon | — | Lab made |
| | barrier | [size: 2-5 μm] | | |
| | enhancing | Miscanthus biocarbon | — | Lab made |
| | agent | [size: 700-900 nm] | | |
| | | Macro-size wood | — | Lab made |
| | | biocarbon | | (FIG. 1A) |
| | | [size: below 400 μm] | | |
| | | Micron-size wood | — | Lab made |
| | | biocarbon | | (FIG. 1B) |
| | | [size: 2-5 μm] | | |
| | | Submicron size wood | — | Lab made |
| | | biocarbon | | (FIG. 1C) |
| | | [size: 700-900 nm] | | |
| | | Soy hull biocarbon | — | Lab made |
| | | [size: 2-5 μm] | | |
| | | Coffee chaff biocarbon | — | Lab made |
| | | [size: 2-5 μm] | | |
| | | Coffee ground biocarbon | — | Lab made |
| | | [size: 2-5 μm] | | |
| | | Oat hull biocarbon | — | Lab made |
| | | [size: 2-5 μm] | | |
| Talc | Filler | Talc [size: 2-5 μm] | HAR T64 | Imerys |
| | | Talc [size: ~1.5 μm] | Jetfine 3CC | Imerys |
| | | Talc [Size: 1-10 μm] | Jetfil (500-700) | Imerys |
| | | Talc [size: ~800 nm] | NANO ACE D- | Nippon Talc Co., |
| | | | 800 | Ltd. Japan |
| | | Talc [size: ~800 nm] | MICROTUFF ® | Minerals |
| | | | AG 609 | Technology |
| Starch | Filler | Corn starch | Hylon VII | Ingredion ® |
| | | [size: ~10 μm] | | |
| Graphite | Filler/Water | Graphite [size: ~3 μm] | Graphene- | NANOXPLORE, |
| | barrier | | black ™ 3X | Canada |
| | reinforcing | | | |
| | agent | | | |
| Wax | Control of | Biowax | TopScreen ™ | SOLENIS, US |
| | MFI, improve | | ED 9 Biowax | |
| | water barrier | | | |
| | properties | | | |

The polymer matrix can be single biodegradable polymer or the binary/ternary polymer blends selected from but not limited to PLA, PBS, Bio-PBS, PBSA, Bio-PBSA, PBAT, PHBV and alike. In the examples provided in this invention, all the polymers mentioned in Table 1 are used here. For barrier comparison, petroleum-based non-biodegradable plastics polypropylene (PP 1120H from Pinnacle Polymers), polyethylene terephthalate (PET Laser®B90 A from Songhan Plastics Technology Co. Ltd, China), Nylon 6 (PA6 Ultramid B27E from BASF, Germany) and EVOH (with 38 mol % ethylene contents) from Sigma-Aldrich, Canada, are compression molded into sheets for barrier testing in this invention.

The blends can be compatibilized in the presence of low contents of free radicals including but not limited to dibenzoyl peroxide, benzoyl peroxide and dicumyl peroxide, 2,5-dimethyl-2,5-di(t-butylperoxy) 3-hexyne; 4-(t-butylperoxy)-4-methyl-2-pentanol; Bis(t˜butylperoxyisopropyl)benzene; Dicumyl peroxide; Ethyl 3,3-bis(t-butylperoxy) butyrate; Ethyl 3,3-bis(t-amylperoxy) butyrate; and, Dibenzoyl peroxide.

The biocarbon can be pyrolyzed from various type of feedstock including but not limited to plant-derived miscanthus fibers, wood, soy hull or other biobased co-products like chicken feathers, distiller grains and peanut shell, etc. The pyrolysis temperature can be changed from 200 to 1500° C., with pyrolysis time ranging from 10 to 60 minutes.

### Methods

### Processing and Compounding of the Biocomposites

Before barrier testing, the biocomposites were compounded in a twin-screw extruder (Leistritz Micro-27, Germany) equipped with screw diameter of 27 mm and an L/D ratio of 48 in one-step extrusion. In the case of bioplastics/40% filler system, the bioplastics (dried in an oven at 80° C. for 24 hr) were added in the main feeder and hybrid fillers (dried in 80° C. for 24 hr) are added in the side feeder. In the case of bioplastics/up to 30% filler system, the bioplastics (dried in an oven at 80° C. for 24 hr) and hybrid fillers were mixed and added in the main feeder to prepare pellets. The feeding speed and extrusion screw speed were 5-8 kg/h and 100 rpm, respectively. Other compounding machines have the same function of twin-screw extruder, including but not limited to Haake mixers or the like, micro-compounders with integrated extrusion and injection molding systems (i.e. DSM micro injection molding or Arburg injection molding), or in any extrude and injection molding systems can be used to process the biocomposites. When an extruder is used, which is the preferred method of processing, strands are produced in a continues process which can be pelletized and further processed by other process method such as injection molding, three roll calendaring, film blowing or the like.

The free radical initiators consisting of organic peroxide group with different chemical structures may be used or not used in the biocomposites, depending on the polymeric matrix and possible applications. The peroxide may be in the form of peroxide, hydroperoxides, peroxy esters and ketone peroxide, including but not limited to 2,5-dimethyl-2,5-di(t-butylperoxy) 3-hexyne, 2, Dicumyl peroxide, Ethyl 3,3-bis(t-butylperoxy) butyrate, Ethyl 3,3-bis(t-amylperoxy) butyrate, and, Dibenzoyl peroxide, etc.

To prepare maleic anhydride-grafted-polymer (MA-g-Polymer), the initiator (less or equal to 1 phr) can be dissolved in acetone (less or equal to 5 ml) and were coated over pre-dried polymer pellets. The powdered MA (less, equal or more than 5 wt %) were added into the above-mentioned coated polymer pellets and mixed manually so that MA can uniformly adhere over the coated pellets. The prepared mixture was fed into a co-rotating twin screw extruder (Micro-27, Leistritz advance technologies corporation, USA), operated at 160-180° C. (all zones), 60 rpm (screw speed) and 5 kg/h (feed rate). The fabricated strands were cooled down after passing through a chilled water bath followed by pelletization.

The processing conditions are listed in Table 2.

TABLE 2
Extrusion parameters and additive concentrations used
for fabrication of in-situ compatibilized composites

| Parameters | Conditions | |
|---|---|---|
| Processing temperature | 120 to 200° | C. |
| Feed Rate | 5-8 | kg/h |
| Screw Speed | 20-150 | rpm |
| Residence time | 0.2-10 | min |
| Hybrid Fillers | 1-40 | wt % |

### Sample Preparation and Characterization

The extruded pellets can be shaped into desired geometry by any conventional polymer processing technique including but not limited to injection molding, compression molding, three-roll calendaring, film blowing, film casting and vacuum thermoforming.

The biocomposites used for barrier testing were compression molded into films or sheets by using a CARVER hydraulic hot press (Carver, Inc, US). Compression molding was performed at temperatures between 120 to 200° C. and 30 MPa by per-heating for 3 min, pressing for 5 min and cooling for 3 min. The thickness of the films and sheets range from 0.1 to 5 mm. Other processing methods to make films or sheets, including but not limited to film casting, film blowing, 3-roll calendaring and injection molding can be used.

The oxygen barrier of compression films/sheets was tested on OX-TRAN 2/21 system (Mocon, US) according to the ASTM standard D 3985-17. The oxygen barrier of coffee pod packaging made by thermoforming was tested by OX-TRAN 2/22 (Mocon, US). The water barrier testing was conducted on PERMATRAN-W 3/33 system (Mocon, US) to the ASTM standard D 6701-16. In the examples provided in this invention, the testing condition of films/sheets for oxygen is 0% relative humidity (RH), 23.7° C., and for water permeation is 100% or 33% RH, 37.8° C. The relative humidity was specified in the table as 100% RH or 33% RH. The oxygen barrier of packaging was tested at 10% RH, 23.7° C. Other testing condition can be used to obtain the oxygen/water barrier of the biocomposites.

Table 3 lists the material identifications used hereafter in this invention and their corresponding formulations. An individual formulation has been defined by an acronym and that acronym has been used further in rest of the tables (from table 4 to table 15).

TABLE 3
Nomenclature of all the fabricated formulations and used for barrier analysis

| Acronym | Formulation |
|---|---|
| 4A | PBS (low MFI) |
| 4B | 85% PBS (low MFI)/15% Miscanthus Biocarbon (Size: 3-5 μm) |
| 4C | 85% PBS (low MFI)/15% Submicron Size Miscanthus Biocarbon |
| | (Size: 700-900 nm) |
| 4D | 85% PBS (low MFI)/15% Macro-size Wood Biocarbon (Size: below 400 μm) |
| 4E | 85% PBS (low MFI)/15% Wood Biocarbon (Size: 3-5 μm) |
| 4F | 85% PBS (low MFI)/15% Submicron Size Wood Biocarbon (Size: 700-900 nm) |
| 4G | PHBV (Y1000P) |
| 4H | 85% PHBV/15% Miscanthus Biocarbon (Size: 3-5 μm) |
| 4I | BioPBS (FD91M) |
| 4J | 85% BioPBS/15% Miscanthus Biocarbon (Size: 3-5 μm) |
| 4K | PLA (4043D) |
| 4L | PLA/15% Miscanthus Biocarbon (Size: 3-5 μm) |

Ternary Blends and Composites

| | |
|---|---|
| 5A | 40% PLA/40% PBS/20% PBAT/0.02 phr Luperox (PST) |
| 5B | 80% PST/20% Starch |
| 5C | 80% PST/20% Talc |
| 5D | 80% PST/20% Miscanthus Biocarbon |
| 5E | 80% PST/20% Graphite |

PBS with Hybrid Fillers

| | |
|---|---|
| 6A | 75% PBS (High MFI)/15% Submicron Size Wood Biocarbon/10% Sub-micron |
| | Size Talc |
| 6B | 70% PBS (High MFI)/15% Macro-Size Wood Biocarbon/15% Sub-micron Size |
| | Talc |
| 6C | 70% PBS (High MFI)/15% Submicron Size Wood Biocarbon/15% Sub-micron |
| | Size Talc |
| 6D | 70% PBS (High MFI)/15% Submicron Size Wood Biocarbon/10% Graphite/5% |
| | Sub-micron Size Talc |
| 6E | 70% PBS (High MFI)/5% Micron-size Miscanthus Biocarbon/5% Talc/15% |
| | Starch/5% Graphite |
| 6F | 60% PBS (High MFI)/5% Micron-size Miscanthus Biocarbon/15% Talc/15% |
| | Starch/5% Graphite |

Binary Blends and Hybrid Composites

| | |
|---|---|
| 7A | PBSA |
| 7B | 70% PBSA/10% Submicron Size Miscanthus Biocarbon/15% Starch/5% Sub- |
| | micron Talc |
| 7C | 70% PBS (High MFI)/30% PBSA |
| 7D | 80% [70% PBS (High MFI)/30% PBSA]/5% Micron-Size Miscanthus |
| | Biocarbon/5% Talc/5% Starch/5% Graphite |
| 7E | 70% [70% PBS (High MFI)/30% PBSA]/5% Micron-Size Miscanthus |
| | Biocarbon/5% Talc/15% Starch/5% Graphite |
| 8A | 80% PBS/20% PBAT/0.02 phr Luperox (HMS) |
| 8B | 60% HMS/15% Starch/15% Talc/5% Micron-Size Wood Biocarbon/5% Graphite |

Quaternary Blend-based Composite

| | |
|---|---|
| 8C | 60% [40% PLA/30% PBS/20% PBAT/10% PHBV/0.02 phr Luperox]/15% |
| | Talc/15% Starch/5% Graphite/5% Micron-size Wood Biocarbon |

PBS with Hybrid Fillers and Compatibilizers

| | |
|---|---|
| 9A | 85% [PBS/0.1 phr Trigonox)/15% Submicron Size Wood Biocarbon |
| 9B | 70% PBS (High MFI)/15% Submicron Size Wood Biocarbon/15% Sub-micron |
| | Size Talc/0.1 phr Trigonox |
| 9C | 70% PBS (High MFI)/15% Submicron Size Wood Biocarbon/5% Sub-micron |
| | Size Talc/10% Graphite/0.1 phr Trigonox |
| 9D | 68% [BioPBS/2% MA-g-PBS]/5% Submicron Size Miscanthus Biocarbon/5% |
| | Talc/15% Starch/5% Graphite |

Ternary Blends and Hybrid Composites

| | |
|---|---|
| 10A | 60% PST/35% Talc/5% Macro-Size Miscanthus Biocarbon |
| 10B | 60% PST/30% Talc/5% Micro-Size Wood Biocarbon/5% Graphite |
| 10C | 60% PST/15% Starch/15% Talc/10% Micro-Size Wood Biocarbon |
| 10D | 60% PST/15% Starch/15% Talc/5% Micron-size Miscanthus Biocarbon/5% |
| | Graphite |
| 11A | 60% PST/15% Starch/15% Talc/5% Micron-size Biocarbon/5% Graphite |
| 11B | 60% PST/15% Starch/15% Talc/5% Micron-size Coffee Chaff Biocarbon/5% |
| | Graphite |
| 11C | 60% PST/15% Starch/15% Talc/5% Micron-size Soy Hull Biocarbon/5% |
| | Graphite |
| 11D | 60% PST/15% Starch/15% Talc/5% Micron-size Oat Hull Biocarbon/5% |
| | Graphite |
| 11E | 60% PST/30% Talc/5% Micron-size Wood Biocarbon/5% Graphite |
| 11F | 60% PST/30% Talc/5% Micron-size Coffee Ground Biocarbon/5% Graphite |

Ternary Blends with Biocarbon-based Composites

| | |
|---|---|
| 12A | 85% [60% PHBV (Low MFI)/40% (BioPBSA/Ecoflex ™(50%))]/15% |
| | Submicron Size Wood Biocarbon |
| 12B | 85% [60% PBS (Low MFI)/40% (BioPBSA/Ecoflex ™(50%))]/15% Submicron |
| | Size Wood Biocarbon |
| 12C | 85% [60% PLA/40% (BioPBSA/Ecoflex(50%))]/15% Submicron Size Wood Biocarbon |

Ternary Blends with Hybrid Fillers and Compatibilizers

| | |
|---|---|
| 13A | 72.5% [60% PHBV/40% (BioPBSA/Ecoflex ™ (50/50))]/1.2% MA-g- |
| | PHBV/0.4% MA-g-BioPBSA/0.4% MA-g-Ecoflex ™/15% Submicron Size |
| | WOOD Biocarbon/10% Submicron Size Talc/0.5% Biowax (Wax in Acetone |
| | Emulsion) |
| 13B | 72.5% [60% PHBV/40% (BioPBSA/Ecoflex ™ (50/50))]/1.2% MA-g- |
| | PHBV/0.4% MA-g-BioPBSA/0.4% MA-g-Ecoflex ™/15% Micron-Size WOOD |
| | Biocarbon/10% Submicron Size Talc/0.5% Biowax (Wax in Acetone Emulsion) |

Petroleum-based Polymers

| | |
|---|---|
| 14A | Nylon 6 (Ultramid B27E) |
| 14B | PET (Laser ®B90A) |
| 14C | EVOH (38 mol % Ethylene) (EVAL F171) |
| 14D | Polypropylene (1120H) |

Injection Molded and Thermoformed Coffee Capsules

| | |
|---|---|
| 15C | Lab Made Injection Molded Compostable Small Coffee Capsule |
| | [70% BioPBS/5% Sub-micron Size Miscanthus Biocarbon/5% Talc/10% |
| | Starch/10% Graphite] |
| 15D | Lab Made Thermoformed Compostable Coffee Capsule |
| | [60% PST/15% Starch/15% Talc/5% Biocarbon/5% Graphite] |
| 15E | Lab Made Thermoformed Compostable Coffee Capsule |
| | [70% (BioPBS/0.1 phr Trigonox)/15% Sub-micron Size Biocarbon/10% |
| | Graphite/5% Sub-micron Size Talc] |
| 15F | Lab Made Injection Molded Compostable Coffee Capsule 72.5% |
| | [60% PHBV/40% (BioPBSA/Ecoflex ™ (50/50))]/1.2% MA-g-PHBV/0.4% MA- |
| | g-BioPBSA/0.4% MA-g- Ecoflex ™/15% Submicron Size WOOD |
| | Biocarbon/10% Sub-micron Size Talc/0.5% Biowax (Wax in Acetone Emulsion) |
| 15G | Lab Made Injection Molded Compostable Coffee Capsule |
| | 72.5% [60% PHBV/40% (BioPBSA/Ecoflex ™(50/50))]/1.2% MA-g- |
| | PHBV/0.4% MA-g-BioPBSA/0.4% MA-g- Ecoflex ™/15% Micro-Size WOOD |
| | Biocarbon/10% Submicron Size Talc/0.5% Biowax (Wax in Acetone Emulsion) |

### Results

### Part 1—Ultra-High Oxygen Barrier Compostable Composites Suitable for Injection Molding

TABLE 4
Ultra-high barrier properties achieved
with the composites of the invention

| | | Oxygen | | Water Permeation |
|---|---|---|---|---|
| Formu- | Thickness | Permeation | Thickness | (g · mil/m²-day) |
| lation | (mm) | (cc · mil/m²-day) | (mm) | @ 33% RH |
| 4A | 0.69 | 219.87 | 0.69 | 91.25 |
| | (±0.02) | (±2.4) | (±0.02) | (±0.7) |
| 4B | 0.8 | 0.52 | 0.8 | 80.86 |
| | (±0.003) | (±0.2) | (±0.003) | (±0.1) |
| 4C | 0.78 | 0.153 | 0.74 | 87.26 |
| | (±0.01) | (±0.04) | (±0.02) | (±2.75) |
| 4D | 0.76 | 61.5 | 0.81 | 62.81 |
| | (±0.002) | (±5.4) | (±0.01) | (±2.8) |
| 4E | 0.73 | 53.50 | 0.82 | 54.65 |
| | (±0.02) | (±1.2) | (±0.007) | (±2.8) |
| 4F | 0.81 | 12.71 | 0.81 | 88.71 |
| | (±0.02) | (±0.28) | (±0.007) | (±4.6) |
| 4G | 0.74 | 14.97 | 0.71 | 7.77 |
| | (±0.11) | (±0.19) | (±0.05) | (±1) |
| 4H | 0.66 | 0.15 | 0.69 | 11.89 |
| | (±0.007) | (±0.001) | (±0.11) | (±1.4) |
| 4I | 0.73 | 229 | 0.9 | 56.5 |
| | (±0.02) | (±1.1) | (±0.02) | (±0.49) |
| 4J | 0.79 | 1.43 | 0.79 | 59.67 |
| | (±0.03) | (±0.02) | (±0.008) | (±0.34) |
| 4K | 0.83 | 571 | 1 | 106.2 |
| | (±0.007) | (±6) | (±0.003) | (±2.2) |
| 4L | 0.83 | 0.164 | 0.79 | 111.81 |
| | (±0.004) | (±0.04) | (±0.01) | (±0.55) |

The effect of the pyrolyzed biocarbon on the oxygen/water barrier properties of the biodegradable polymer PBS, PHBV, PLA and BioPBS is presented in Table 4. With introduction of 15% micro-size miscanthus fiber biocarbon into PBS by melt blending (4B), the oxygen permeation of PBS decreased from 219.87 to 0.52 cc·mil/m²-day-atm, a dramatic improvement rarely reported with other fillers. In addition, the water permeation of the composites is improved by 11.4% than that of pure PBS. This results from the increased solubility of PBS with incorporation of water absorbent biocarbon.

The oxygen barrier can be further improved via decreasing the biocarbon size from macro-size (below 400 μm) (4D) to sub-micron (700-900 nm) (4F), as shown in Table 4. The oxygen permeability decreased from 61.5 to 12.71 cc·mil/m²-day with 15% sub-micron wood biocarbon.

With introduction of 15% micro-sized miscanthus fiber biocarbon into PHBV by melt blending (4H), the oxygen permeation of PHBV decreased from 14.97 to 0.15 cc·mil/m²-day-atm.

With introduction of 15% micron-sized miscanthus fiber biocarbon into BioPBS by melt blending, the oxygen permeation of BioPBS decreased from 229 (4I) to 1.43 cc·mil/m²-day-atm (4J).

With introduction of 15% micro-sized miscanthus fiber biocarbon into PLA (4L) by melt blending, the oxygen permeation of PLA decreased from 571 to 0.164 cc·mil/m²-day-atm.

TABLE 5
Effect of adding different fillers individually to the biopolymer
blends on their oxygen and water vapor barrier properties

| | | Oxygen | | Water Permeation |
|---|---|---|---|---|
| Formu- | Thickness | Permeation | Thickness | (g · mil/m²-day) |
| lation | (mm) | (cc · mil/m²-day) | (mm) | @ 100% RH |
| 5A | 1.05 | 848.5 | 1.05 | 442 |
| | (±0.05) | (±157.5) | (±0.05) | (±7.1) |
| 5B | 0.8 | 439.9 | 0.75 | 418.0 |
| | (±0.002) | (±12.8) | (±0.04) | (±5.4) |
| 5C | 1 | 185.2 | 0.88 | 182.2 |
| | (±0.04) | (±3.3) | (±0.03) | (±8.5) |
| 5D | 0.86 | 1.5 | 0.86 | 259.0 |
| | (±0.04) | (±1.1) | (±0.04) | (±12.4) |
| 5E | 0.63 | 247.4 | 0.65 | 121.3 |
| | (±0.03) | (±15.4) | (±0.02) | (±12.2) |

To clarify the effects of different fillers on the barrier improvement of the polymer matrix, individual fillers were added to the polymer matrix to check the barrier improvement (Table 5). Among all four different fillers, the biocarbon shows the highest improvement in the oxygen barrier while graphite shows the highest in water barrier improvement, indicating the biocarbon is favorable to the oxygen barrier and graphite can improve the water barrier. Therefore, to achieve the oxygen/water barrier performance balance, a hybrid filler system was developed. The effect of incorporating individual fillers including starch, talc, biocarbon and graphite on the barrier properties (oxygen and water) of ternary polymer blend (PLA/PBS/PBAT) is presented in Table 5. With the introduction of 20% starch into the polymer blend by melt blending, the oxygen permeation of the polymer blend decreased from 848.5 to 439.9 cc·mil/m²-day-atm. Similarly, the oxygen permeation of PLA/PBS/PBAT polymer blend decreased from 848.5 to 185.2, 1.5 and 247.4 cc·mil/m²-day-atm with the introduction of 20% talc, biocarbon and graphite, respectively.

TABLE 6
The effects of hybrid fillers on the
oxygen/water barrier of biopolymer

| | | Oxygen | | Water Permeation |
|---|---|---|---|---|
| Formu- | Thickness | Permeation | Thickness | (g · mil/m²-day) |
| lation | (mm) | (cc · mil/m²-day) | (mm) | @ 33% RH |
| 6A | 0.66 | 4.78 | 0.66 | 40.66 |
| | (±0.02) | (±0.5) | (±0.02) | (±4.3) |
| 6B | 0.64 | 18.17 | 0.66 | 70.95 |
| | (±0.004) | (±0.9) | (±0.02) | (±1.7) |
| 6C | 0.67 | 2.79 | 0.67 | 65.23 |
| | (±0.007) | (±0.9) | (±0.007) | (±2.5) |
| 6D | 0.9 | 6.4 | 0.93 | 29.4 |
| | (±0.03) | (±0.8) | (±0.04) | (±0.7) |
| 6E | 0.63 | 0.07 | 0.60 | 32.73 |
| | (±0.02) | (±0.03) | (±0.0007) | (±0.7) |
| 6F | 0.86 | 3.13 | 0.82 | 42 |
| | (±0.07) | (±0.05) | (±0.07) | (±0.1) |

By mixing biocarbon with talc in various percentages (10 and 15 wt %), the oxygen permeation can be decreased to as low as 4.78 and 2.79 cc·mil/m²-day, respectively (as shown in Table 6, rows 6A, 6B, and 6C). However, the water vapor permeation was affected in an opposite manner as compared to oxygen permeation. Meantime, the water barrier can be improved via using hybrid fillers of biocarbon/talc/graphite or biocarbon/talc/starch/graphite (6D, 6E).

The hybrid filler system also greatly improves the oxygen barrier of biodegradable PBS, as shown in Table 6. The hybrid fillers of biocarbon/talc/starch/graphite are introduced into PBS to improve the oxygen/water barrier. The oxygen permeation can be decreased up to 0.07 cc·mil/m²-day, which can be used in applications requiring ultra-high oxygen barrier.

TABLE 7
Oxygen and water barrier analysis of biodegradable
polymers and their composites

| | | Oxygen | | Water Permeation |
|---|---|---|---|---|
| Formu- | Thickness | Permeation | Thickness | (g · mil/m²-day) |
| lation | (mm) | (cc · mil/m²-day) | (mm) | @ 33% RH |
| 7A | 1.05 | 842.55 | 1.07 | 134.72 |
| | (±0.01) | (±10.7) | (±0.007) | (±1.42) |
| 7B | 0.92 | 2.46 | 0.9 | 127 |
| | (±0.02) | (±0.03) | (±0.03) | (±2.1) |
| 7C | 0.67 | 326.04 | 0.67 | 64.15 |
| | (±0.009) | (±4.40) | (±0.007) | (±2.1) |
| 7D | 0.85 | 1.29 | 0.86 | 30.4 |
| | (±0.007) | (±1.2) | (±0.001) | (±0.7) |
| 7E | 0.86 | 0.97 | 0.86 | 13.2 |
| | (±0.007) | (±0.5) | (±0.007) | (±0.9) |

With hybrid fillers of biocarbon with starch and talc, the oxygen and water barrier of PBSA (7A) can be improved from 842.55 to 2.46 cc·mil/m²-day and from 134.72 to 127.6 g·mil/m²-day, respectively (7B). PBSA is reported as being a home-compostable biopolymer. Ultra-high oxygen barrier can be achieved in home compostable polymer systems using biocarbon.

The oxygen barrier of a compostable polymer blend of PBS and PBSA (7C) was significantly improved from 326.04 to 1.29 cc·mil/m²-day (7D) with the addition of hybrid fillers (biocarbon, talc, starch and graphite). It clearly demonstrates that the addition of hybrid filler into tough polymer blends can highly improve the oxygen barrier property.

### Part 2—Ultra-High Oxygen Barrier Compostable Composites Suitable for Film/Sheet Fabrication

TABLE 8
Barrier properties of biodegradable polymer
binary blend (PBS/PBAT) and its composites

| | | Oxygen | | Water Permeation |
|---|---|---|---|---|
| Formu- | Thickness | Permeation | Thickness | (g · mil/m²-day) |
| lation | (mm) | (cc · mil/m²-day) | (mm) | @ 100% RH |
| 8A | 1.05 | 786.67 | 1.05 | 851.58 |
| | (±0.01.) | (±5.2) | (±0.01) | (±3.8) |
| 8B | 0.81 | 1.36 | 0.79 | 277.85 |
| | (±0.05) | (±1.1) | (±0.03) | (±12.6) |
| 8C | 0.85 | 2.96 | 0.85 | 265.4 |
| | (±0.05) | (±0.9) | (±0.05) | (±2.2) |

In a PBS/PBAT binary blend with hybrid fillers (15% starch/15% talc/5% biocarbon/5% graphite) (8B), we find oxygen barrier can be increased by 578 times from 786 to 1.36 cc·mil/m²-day compared to an unfilled blend (8A), as shown in Table 8. In addition to the excellent oxygen barrier, the hybrid filler system also improves the water barrier. The water vapor permeation of the HMS composite is reduced from 851.6 to 277.8 g·mil/m²-day, a 3-fold improvement from the binary blends without hybrid fillers. The barrier of a quaternary blend (PLA/PBS/PBAT/PHBV blend) with the invented hybrid filler system is also shown in Table 8. The results indicate that the hybrid filler system works in quaternary blends, with excellent oxygen barrier of 2.96 cc·mil/m²-day-atm.

TABLE 9
Barrier analysis of biodegradable PBS composites
with different compatibilizers

| | | Oxygen | | Water Permeation |
|---|---|---|---|---|
| Formu- | Thickness | Permeation | Thickness | (g · mil/m²-day) |
| lation | (mm) | (cc · mil/m²-day) | (mm) | @ 33% RH |
| 9A | 0.89 | 0.19 | 0.89 | 287 |
| | (±0.01) | (±0.002) | (±0.01) | (±2.8) |
| 9B | 0.75 | 1.43 | 0.75 | 60.28 |
| | (±0.03) | (±0.02) | (±0.03) | (±1.3) |
| 9C | 0.76 | 2.5 | 0.76 | 44 |
| | (±0.03) | (±0.05) | (±0.03) | (±1.8) |
| 9D | 0.74 | 0.05 | 0.70 | 40.89 |
| | (±0.05) | (±1.1) | (±0.01) | (±1.3) |

Different compatibilizers can be used in the biodegradable composites to improve the interaction between the fillers and polymeric matrix. With the addition of compatibilizers, the oxygen barrier can be further improved, as shown in Table 9. Compared to PBS composites without Luperox (4F), the oxygen permeation can be decreased from 12.71 to 0.19 cc·mil/m²-day (9A). Another compatibilizer, maleic anhydride grafted PBS (MA-g-PBS), has been used into the BioPBS-based composite (9D), further improving the oxygen permeation to 0.05 cc·mil/m²-day.

TABLE 10
Barrier properties of biodegradable polymer ternary
blend (PLA/PBS/PBAT) and its composites

| | | Oxygen | | Water Permeation |
|---|---|---|---|---|
| Formu- | Thickness | Permeation | Thickness | (g · mil/m²-day) |
| lation | (mm) | (cc · mil/m²-day) | (mm) | @ 100% RH |
| 10A | 0.96 | 10.4 | 0.95 | 175.4 |
| | (±0.002) | (±0.08) | (±0.002) | (±5.8) |
| 10B | 0.8 | 14.9 | 0.96 | 129.5 |
| | (±0.05) | (±2.3) | (±0.01) | (±3.2) |
| 10C | 0.8 | 17.9 | 0.83 | 322.5 |
| | (±0.02) | (±7.1) | (±0.01) | (±6.5) |
| 10D | 0.8 | 0.15 | 0.87 | 209.6 |
| | (±0.01) | (±0.02) | (±0.03) | (±1.4) |

The effects of biocarbon and hybrid fillers on the oxygen/water barrier of the ternary biodegradable polymer blends (PLA/PBS/PBAT (40/40/20)) are shown in Table 10. In these biocomposites, the incorporation of biocarbon can decrease the oxygen permeation by 99.8%, i.e., from 848.5 (5A) to 1.5 cc·mil/m²-day-atm (5D). The water permeation of the blends is also decreased by 41% from 442 to 259 g·mil/m²-day. Introducing hybrid fillers including talc and graphite could improve the water barrier by 50%, to a permeation value of 129 gm·mil/m²-day (10B), with a moderate sacrifice of the oxygen barrier. Table 10 also shows a comparison of the oxygen barrier with (10D) and without starch (10B) at low biocarbon contents. Starch/biocarbon hybrid filler system can further improve the oxygen barrier from 15.0 to 0.15 cc·mil/m²-day-atm, because of the good oxygen barrier properties of starch. Graphite can be used to improve the water vapor barrier. With the introduction of graphite, the water barrier improved by 26% (10A vs 10B). Another example was given in formulation number 7B which has starch but no graphite, in comparison of number 10D with both starch and graphite. It is found that the water vapor permeation increases when starch is used without graphite, which is expected given the hydrophilic nature of starch. Overall, the hybrid filler systems exhibit outstanding performances in improving the oxygen barrier.

TABLE 11
High oxygen barrier of the biocomposites filled with different types of biocarbon

| | | | | | Water |
|---|---|---|---|---|---|
| | | | Oxygen | | Permeation |
| Formu- | Biocarbon | Thickness | Permeation | Thickness | (g · mil/m²-day) |
| lation | Used | (mm) | (cc · mil/m²-day) | (mm) | @ 100% RH |
| 11A | Wood | 1.1 | 18.6 | 1 | 135.5 |
| | Biocarbon | (±0.02) | (±1.5) | (±0.02) | (±2.4) |
| 10D | Miscanthus | 0.81 | 0.15 | 0.87 | 209.6 |
| | Biocarbon | (±0.01) | (±0.005) | (±0.01) | (±1.3) |
| 11B | Coffee Chaff | 0.62 | 0.63 | 0.64 | 234.3 |
| | Biocarbon | (±0.03) | (±0.003) | (±0.03) | (±3.1) |
| 11C | Soy Hull | 0.62 | 0.81 | 0.72 | 295.7 |
| | Biocarbon | (±0.02) | (±0.03) | (±0.03) | (±1.4) |
| 11D | Oat Hull | 0.73 | 0.18 | 0.66 | 226.4 |
| | Biocarbon | (±0.01) | (±0.005) | (±0.004) | (±3.1) |
| 11E | Wood | 0.8 | 14.9 | 0.96 | 129.5 |
| | Biocarbon | (±0.002) | (±0.8) | (±0.01) | (±1.6) |
| 11F | Coffee Ground | 0.95 | 1.5 | 0.99 | 163.2 |
| | Biocarbon | (±0.01) | (±0.03) | (±0.03) | (±2.4) |

The effect of biocarbon type (pyrolyzed from different biomass at 500-600° C. for 30 min, followed by 2 hr ball milling) on the barrier properties of the PLA/PBS/PBAT ternary blends are presented in Table 11. Biocarbon from different biobased resources, including but not limited to Miscanthus fiber, wood, coffee chaff, oat hull and soy hull, can be used as fillers to fabricate high oxygen barrier biodegradable polymer composites. Different types of biocarbon can be used in this invention. The biocarbon pyrolyzed from Miscanthus fiber and oat hull is relatively better for oxygen barrier and the wood biocarbon is relatively better for the water barrier. As already shown in Table 4, adjusting the particle size of the biocarbon can impact barrier properties. The difference can be attributed to the differences in porosity, pore-volume, specific surface area and polarity, which can be influenced by the biomass feedstock as well as pyrolysis conditions. All examples show excellent improvements in oxygen barrier properties.

TABLE 12
Barrier analysis of biodegradable polymer
ternary blend and their composites

| | | Oxygen | | Water Permeation |
|---|---|---|---|---|
| Formu- | Thickness | Permeation | Thickness | (g · mil/m²-day) |
| lation | (mm) | (cc · mil/m²-day) | (mm) | @ 33% RH |
| 12A | 0.68 | 30.6 | 0.66 | 65.81 |
| | (±0.004) | (±0.06) | (±0.009) | (±2.5) |
| 12B | 0.85 | 14.6 | 0.85 | 149.5 |
| | (±0.02) | (±0.5) | (±0.02) | (±4.1) |
| 12C | 1 | 38.34 | 1 | 156.1 |
| | (±0.001) | (±0.7) | (±0.001) | (±0.3) |

The effect of blending crystalline/semicrystalline polymers (as dominant phase) and amorphous polymer/polymer (as minor phase) on the barrier properties of biocarbon composites is analyzed and compared in Table 12. With the introduction of 60% crystalline/semicrystalline polymer i.e. PHBV (12A), PBS (12B) or PLA (12C) into an amorphous polymer blend i.e. BioPBSA and Ecoflex™ in the presence of biocarbon by melt blending, the oxygen permeation was decreased to 14.6 cc·mil/m²-day-atm. It means that the oxygen barrier has been improved by the addition of crystalline/semicrystalline polymers, which is rarely reported with other fillers.

TABLE 13
Barrier analysis of biodegradable polymer-based composites

| | | Oxygen | | Water Permeation |
|---|---|---|---|---|
| Formu- | Thickness | Permeation | Thickness | (g · mil/m²-day) |
| lation | (mm) | (cc · mil/m²-day) | (mm) | @ 33% RH |
| 13A | 0.71 | 1.88 | 0.71 | 50.70 |
| | (±0.01) | (±0.0006) | (±0.01) | (±4.2) |
| 13B | 0.69 | 33.5 | 0.69 | 62.12 |
| | (±0.02) | (±0.05) | (±0.02) | (±2.4) |

A ternary blend of PHBV, BioPBSA and Ecoflex™ (13A) showed very high oxygen barrier (1.88 cc·mil/m²·day) in the presence of hybrid fillers, compatibilizers and biowax as shown in Table 13. The addition of wax in the formulations also improved the water barrier of the ternary blend.

TABLE 14
Comparison of the barrier properties of a representative biocomposite
of this invention and common petroleum-based polymers

| | | Water Permeation |
|---|---|---|
| | Oxygen Permeation | (g · mil/m²-day) |
| Formulation | (cc · mil/m²-day) | @ 100% RH |
| 10D | 0.15 (±0.02) | 209.6 (±1.4) |
| 14A | ~6.3 | 373 (±2.8) |
| 14B | ~51 | ~25.9 |
| 14C | ~2.2 | ~13 |
| 14D | ~2458 | ~12.2 |

Notes:
PET (polyethylene terephthalate)-DAK Americas Laser ®B90A from Songhan Plastics Technology Co. Ltd.; Nylon 6-Ultramide B27E from BASF; EVOH (38% mol ethylene)-Ethylene vinyl alcohol copolymer (Sigma-Aldrich); PP (polypropylene) grade 1120H from Pinnacle Polymers.

A comparison of oxygen and water vapor barrier properties between a representative biodegradable polymer composite with a biocarbon-based hybrid filler (10D) and petroleum-based polymers is presented in Table 14. It is clearly observed that the biodegradable polymer composites of this invention show highly improved oxygen barrier as compared to the petroleum-based polymers.

TABLE 15
Barrier comparison between single use coffee capsules thermoformed
or injection molded from the biocomposites of this invention

| | Oxygen Permeation |
|---|---|
| Formulation | (cc-mil/pkg · day) |
| 15C | 3.45 |
| 15D | 4.26 |
| 15E | 11.68 |
| 15F | 0.06 |
| 15G | 0.17 |

Table 15 presents the oxygen barrier comparison between capsules made from our invented biocomposites with hybrid fillers. The developed biocomposites presented herein can be used to replace EVOH, PET and similar materials to make a variety of packaging products. Based on the invented formulations, single-serve coffee capsules were thermoformed and injection molded in the lab-scale and their barrier performances were compared (Table 15). The oxygen barrier properties of the coffee capsules made from the composites of the present invention (15C-15G) can be reasonably expected to extend the shelf-life to the food products.

### REFERENCE

[1] Pasbrig E., Blister Pack, US Patent: US 2006/0283758 A1, Alcan Technology & Management Ltd., Neuhausen am Rheinfall (CH); 2006.
[2] Watanabe Hiroaki, Lee M. S., High Barrier Flexible Packaging Structure, United States patent: U.S. Pat. No. 7,252,878 B2, Toray Plastics (America), Inc., N. Kingstown, R.I. (US); 2007.
[3] Schaefer S. E., Knott J. E., Multiple Layer Packaging Film, United States patent: U.S. Pat. No. 4,389,450A, American Can Company, Greenwich, Conn.; 1983.
[4] Salame M., Steingiser S., Barrier Polymers. Polymer-Plastics Technology and Engineering. 1977; 8: 155-75.
[5] Tropsha Y. G., Clarke R. P., Antoon M. K., Barrier Coating, United States patent: U.S. Pat. No. 5,654,054A, Becton, Dickinson and Company, Franklin Lakes, N. J.; 1997.
[6] Zhang T., Yu Q., Fang L., Wang J., Wu T., Song P., All-Organic Multilayer Coatings for Advanced Poly(lactic acid) Films with High Oxygen Barrier and Excellent Antifogging Properties. ACS Applied Polymer Materials. 2019; 1:3470-76.
[7] Drieskens M., Peeters R., Mullens J., Franco D., Lemstra P. J., Hristova-Bogaerds D. G., Structure versus properties relationship of poly(lactic acid). I. Effect of crystallinity on barrier properties. Journal of Polymer Science Part B: Polymer Physics. 2009; 47:2247-58.
[8] Delpouve N., Stoclet G., Saiter A., Dargent E., Marais S., Water Barrier Properties in Biaxially Drawn Poly(lactic acid) Films. The Journal of Physical Chemistry B. 2012; 116:4615-25.
[9] Xie L., Xu H., Chen J. B., Zhang Z. J., Hsiao B. S., Zhong G. J., Chen J., Li Z. M., From Nanofibrillar to Nanolaminar Poly(butylene succinate): Paving the Way to Robust Barrier and Mechanical Properties for Full-Biodegradable Poly(lactic acid) Films. ACS Applied Materials & Interfaces. 2015; 7:8023-32.
[10] Zhou S. Y., Huang H. D., Ji X., Yan D. X., Zhong G. J., Hsiao B. S., Li Z. M., Super-Robust Polylactide Barrier Films by Building Densely Oriented Lamellae Incorporated with Ductile in Situ Nanofibrils of Poly(butylene adipate-co-terephthalate). ACS Applied Materials & Interfaces. 2016; 8:8096-109.
[11] Katsumoto K., Ching T. Y., Theard L. P., Current S. P., Multi-Component Oxygen Scavenger System Useful in Film Packaging, United States patent: U.S. Pat. No. 5,660,761A, Chevron Chemical Company, San Ramon, Calif.; 1997.
[12] Katsumoto K., Ching T. Y., Multi-Component Oxygen Scavenging Composition, United States patent: U.S. Pat. No. 5,776,361A, Chevron Chemical Company. San Ramon, Calif.; 1998.
[13] Buzarovska A., Bogoeva-Gaceva G., Fajgar R., Effect of the talc filler on structural, water vapor barrier and mechanical properties of poly (lactic acid) composites. Journal of Polymer Engineering. 2016; 36:181-8.
[14] Porter J. P., Ray W. D., High Density Polyethylene Article with Oxygen barrier Properties, United States patent: U.S. Pat. No. 5,153,039A, Paxon Polymer Company, L.P., Baton Rouge, La.; 1992
[15] Choudalakis G., Gotsis A., Permeability of polymer/clay nanocomposites: a review. European polymer journal. 2009; 45:967-84.
[16] Xu H., Wu D., Yang X., Xie L., Hakkarainen M., Thermostable and impermeable “nano-barrier walls” constructed by poly (lactic acid) stereocomplex crystal decorated graphene oxide nanosheets. Macromolecules. 2015; 48:2127-37.
[17] Dhar P., Gaur S. S., Soundararaj an N., Gupta A., Bhasney S. M., Milli M., Kumar A., Katiyar V., Reactive Extrusion of Polylactic Acid/Cellulose Nanocrystal Films for Food Packaging Applications: Influence of Filler Type on Thermomechanical, Rheological, and Barrier Properties. Industrial & Engineering Chemistry Research. 2017; 56:4718-35.
[18] Gorrasi G., Pantani R., Murariu M., Dubois P., PLA/Halloysite Nanocomposite Films: Water Vapor Barrier Properties and Specific Key Characteristics. Macromolecular Materials and Engineering. 2014; 299:104-15.
[19] Pal A. K., Katiyar V., Nanoamphiphilic chitosan dispersed poly (lactic acid) bionanocomposite films with improved thermal, mechanical, and gas barrier properties. Biomacromolecules. 2016; 17:2603-18.
[20] Dobreski D. V., Wu W. P., Polymer Films with Treated Fillers and Improved Properties and Products and Methods Using Same. United States patent: US20090286023A1, Pactiv Corporation, Lake Forest, Ill. (US); 2009.
[21] Sohi S. P., Krull E., Lopez-Capel E., Bol R., A review of biochar and its use and function in soil. Advances in agronomy: Elsevier; 2010; 105:47-82.
[22] Mohanty A. K., Vivekanandhan S., Pin J. M., Misra M., Composites from renewable and sustainable resources: Challenges and innovations. Science. 2018; 362:536-42.
[23] Wang T., Rodriguez-Uribe A., Misra M., Mohanty A. K., Sustainable Carbonaceous Biofiller from Miscanthus: Size Reduction, Characterization, and Potential Bio-composites Applications. BioResources. 2018; 13:3720-39.
[24] Lehmann J., Rillig M. C., Thies J., Masiello C. A., Hockaday W. C., Crowley D., Biochar effects on soil biota—A review. Soil Biology and Biochemistry. 2011; 43:1812-36.
[25] Gu X., Wang Y., Lai C., Qiu J., Li S., Hou Y., Martens W., Mahmood N., Zhang S., Microporous bamboo biochar for lithium-sulfur batteries. Nano Research. 2015; 8:129-39.
[26] Inyang M., Gao B., Yao Y., Xue Y., Zimmerman A., Mosa A., Pullammanappallil P., Ok Y. S., Cao X., A review of biochar as a low-cost adsorbent for aqueous heavy metal removal. Critical Reviews in Environmental Science and Technology. 2016; 46:406-33.
[27] Snowdon M. R., Wu F., Mohanty A. K., Misra M., Comparative study of the extrinsic properties of poly (lactic acid)-based biocomposites filled with talc versus sustainable biocarbon. RSC advances. 2019; 9:6752-61.
[28] Li Z., Reimer C., Wang T., Mohanty A. K., Misra M., Thermal and mechanical properties of the biocomposites of miscanthus biocarbon and poly (3-Hydroxybutyrate-co Hydroxyvalerate)(PHBV). Polymers. 2020; 12:1300.

Through the embodiments that are illustrated and described, the currently contemplated best mode of making and using the invention is described. Without further elaboration, it is believed that one of ordinary skill in the art can, based on the description presented herein, utilize the present invention to the full extent. All publications cited herein are incorporated by reference.

Although the description above contains many specificities, these should not be construed as limiting the scope of the invention, but as merely providing illustrations of some of the presently embodiments of this invention.

1. A gas barrier substrate comprising a biodegradable composite, the biodegradable composite comprising a polymeric matrix and a sustainable filler comprising biocarbon, wherein the biodegradable composite has an oxygen transmission rate of 55 cc/m²-day or less, or an oxygen transmission rate of 20 cc/m²-day or less, or an oxygen transmission rate of 10 cc/m²-day or less, or an oxygen transmission rate of 2 cc/m²-day or less, or an oxygen transmission rate of 1 cc/m²-day or less, or an oxygen transmission rate of 0.2 cc/m²-day or less, wherein the oxygen transmission rate is calculated at normalized thickness of the biodegradable composite of 25.4 micrometer (1 mil) at 0% relative humidity, 23.7° C.

2. The gas barrier substrate of claim 1, wherein the biodegradable composite has a water permeation rate of 300 g/m²-day, or less or has a water permeation rate of 150 g/m²-day or less, or a water permeation rate of 130 g/m²-day or less, or a water permeation rate of 125 g/m²-day or less or a water permeation rate of 10 g/m²-day or less, wherein the water permeation rate is calculated at normalized thickness of the biodegradable composite of 25.4 micrometer (1 mil) at 100% relative humidity, 37.8° C.

3. The gas barrier substrate of claim 1, wherein the polymeric matrix comprises one or more biodegradable polymers.

4. The gas barrier substrate of claim 3, wherein the polymer matrix comprises one or more of polylactide (PLA), poly(butylene succinate) (PBS), BioPBS (bio-based PBS), poly(butylene succinate adipate) (PBSA), BioPBSA (bio-based PBSA), poly(butylene adipate-co-terephthalate) (PBAT), polyhydroxyalkanoates (PHAs) including poly(3-hydroxy)butyrate (PHB) and poly(3-hydroxybutyrate-hydroxyvalerate) (PHBV), and a copolyester of 1.4-butanediol, adipic acid and terephthalic acid.

5. The gas barrier substrate of claim 4, wherein the polymeric matrix comprises a binary blend of PBS/PBSA, PBS/PBAT, BioPBSA/the copolyester of 1.4-butanediol, adipic acid and terephthalic acid or PBSA/PBAT, or a ternary blend of PLA/PBS/PBAT, PHBV/BioPBSA/the copolyester of 1.4-butanediol, adipic acid and terephthalic acid or PBSA/PBAT/PHBV, or a quaternary blend of PLA/PBS/PBAT/PHBV or PLA/BioPBS/PBAT/PHBV.

6. The gas barrier substrate of claim 1, wherein the polymeric matrix comprises PBS, PHBV or PLA as a major component of the polymeric matrix.

7. The gas barrier substrate of claim 1, wherein the biodegradable composite is free of ethylene vinyl alcohol (EVOH) or polyvinyl alcohol (PVOH).

8. The gas barrier substrate of claim 1, wherein the sustainable filler is a hybrid filler comprising (a) the biocarbon, and (b) a second filler selected from one or more of: starch; inorganic mineral fillers from talc or clay; and graphite or graphene.

9. (canceled)

10. (canceled)

11. The gas barrier substrate of claim 1, wherein the biodegradable composite comprises up to 40 wt % of sustainable fillers.

12. The gas barrier substrate of claim 1, wherein the gas barrier substrate is in the form of a pellet, a granule, an extruded solid, an injection molding solid, a hard foam, a sheet, a layer, a film, a dough or a melt.

13. (canceled)

14. The gas barrier substrate of claim 1, wherein the oxygen transmission rate of the gas barrier substrate is lower than the oxygen transmission rate of each one of PET, Nylon or EVOH.

15. The gas barrier substrate of claim 1, wherein the biocarbon is one or more of pyrolyzed miscanthus, pyrolyzed coffee chaff, pyrolyzed soy hull, pyrolyzed wood, pyrolyzed coffee ground or pyrolyzed oat hull.

16. The gas barrier substrate of claim 1, wherein the biodegradable composite further comprises a compatibilizer from peroxide or maleic anhydride-grafted biopolymers.

17. The gas barrier substrate of claim 1, wherein the gas barrier substrate is industrial compostable or home compostable.

18. The gas barrier substrate of claim 1, wherein the gas barrier substrate is a single layer gas barrier.

19. The gas barrier substrate of claim 1, wherein the gas barrier substrate is a multilayer gas barrier film, wherein at least one layer that forms the multilayer film exhibits gas barrier properties.

20. An article of manufacture comprising the gas barrier substrate of claim 1.

21. The article of manufacture of claim 20, wherein the article of manufacture is a packaging in shape of film, sheet, injection molded or thermoformed shapes.

22. The article of manufacture of claim 20, wherein the article of manufacture is a packaging in shape of a coffee pod.

23. A method of limiting gas permeation into an interior of a package, the method comprising at least partially or entirely covering the package with the article defined in claim 20.

24. (canceled)

25. A method of improving shelf life of a material which shelf life is reduced when exposed to a gas, the method comprising at least partially or entirely covering the material with the gas barrier substrate of claim 1.

26. The method of claim 25, wherein the material is at least one of foods, pharmaceuticals, cosmetics, cement, and daily necessaries.
